(19) United States
(12) Patent Application Publication
(10) Pub. No.: US 2007/0259286 A1
(43) Pub. Date: Nov. 8, 2007

(54) Reversible Piezochromic Systems

(76) Inventor: Nathalie Leroux, Bouguenais (FR)

Correspondence Address: DICKSTEIN SHAPIRO, 1177 AVENUE OF THE AMERICAS (6TH AVENUE), NEW YORK, NY, 10036-2714, US

(21) Appl. No.: 10/592,492

(22) PCT Filed: Feb. 9, 2005
(86) PCT No.: PCT/US05/04158

§ 371 Date: Jul. 11, 2007

Related U.S. Application Data
(60) Provisional application No. 60/552,648, filed on Mar. 12, 2004.

(51) Int. Cl. C09D 11/02; G03C 1/00

(52) U.S. Cl. 430/270.1; 106/31.13; 106/31.27; 106/31.43; 106/31.49; 106/31.51

(57) ABSTRACT

The present invention provides a reversible piezochromic system that gives high contrast images upon an application of pressure to the system. The system has a short color-reversal time and can be prepared inexpensively by admixing a suitable electron donating compound and a suitable electron accepting compound. The reversible piezochromic systems of the present invention are useful for preparing a printing ink that can be used to print, for example, banknotes, to prevent forgeries.

### FIELD OF INVENTION

The invention relates to reversible piezochromic systems that are suitable for preparing printing inks. The reversible piezochromic systems of the present invention provide printed images having high contrasts and a short color-reversal time. Furthermore, the piezochromic systems of the invention are prepared inexpensively compared to prior systems and useful for printing, for example, banknotes, to prevent forgery

### BACKGROUND OF INVENTION

Piezochromic substances change color when pressure is applied. Experimental studies have been undertaken on the systems using such substances, but very few commercial applications have resulted from these studies.

The intrinsic color of a piezochromic substance is due to the absorption of light in specific regions of the excitation spectrum as a result of jump of an electronic transition from the ground state to a state of higher energy. When a pressure is applied to the substance, these energy states are perturbed, giving rise to a change in color of the substance. It has been noted that discontinuous change of color occurs when a crystalline solid undergoes a first order phase transition from one crystal structure to another. A change in color may also be induced by a change in molecular geometry which makes up the substance. In the case of mesomorphic substances, the piezochromic effect occurs because of a change in a Braggs diffraction angle for a given wavelength, which, in turn, results from a mechanical force, such as a shearing force and a friction, that induces a change in refractive index.

Known reversible piezochromic substances include derivatives of imidazole, pyrrole, bianthrone, xanthylidene anthrone, dixanthylene, helianthrone and mesonaphthobianthrone.

Numerous methods are known for producing piezochromic systems. Japan Kokai 42880 discloses piezochromic compounds based on spirobenzopyranoxadiazoline derivatives. Japan Kokai 46079 describes a piezochromic compound based on spiropyranthiopyrans. Japan Kokai 132857 discloses a piezochromic compound based on hydrocarboxylic acid derivatives. U.S. Pat. No. 5,320,784 describes a piezochromic compound which can be intensively colored and is a single crystal based on indolinospirobenzo-thiopyran derivatives. U.S. Pat. No. 5,501,945 discloses dyes, within polymers in a packaging materials, which respond to specific stimuli (e.g., temperature, pressure, chemicals, radiation, etc.) and are thermochromic, piezochromic, chemichromic and photochromic. U.S. Pat. Nos. 6,261,469 and 6,517,763 describe piezochromic systems based on three dimensional structures having periodicities on the scale of optical wavelengths.

There are major drawbacks to those systems discussed above. For instance, only a very weak contrast effect is observed, if any effect is observable at all. Further, the effect is not reversible, or if it is, the relaxation time of these media (i.e., the time required for them to return to their initial color state) is very long (e.g., 5 minutes or more). Finally, a certain thickness as well as a black background is required in order for these systems to produce a visible effect. Moreover, the systems generally require an expensive multi-step process for the synthesis of the chemicals. For these reasons, the previously known piezochromic systems are not suitable for applying to printing ink formulations.

Thus, there exists a need for a reversible piezochromic system suitable for use in printing inks. A need further exists for a high-contrast reversible piezochromic system with a short relaxation time. Furthernore, there is a need for a reversible piezochromic system which can be printed on any substrate and/or background color. Finally, there is a need for a reversible piezochromic system which is easy to process and does not require long and expensive, multi-step syntheses for the preparation.

### SUMMARY OF INVENTION

This invention is based, in part, on a discovery by the present inventor that the above objectives can be realized by a combination of one or more ionochromic compounds and a color developer, the latter of which comprises one or a mixture of components having acidity strong enough to develop the color of the ionochromic compound by protonation, and yet weak enough to allow the reversibility of the system. The ionic exchange between the both components, causes color changes of the mixture and is triggered by only a weak pressure to the system.

Other objects and advantages of the present invention will become apparent from the following descriptions and appended claims.

### DETAILED DESCRIPTION OF THE INVENTION

The present invention is a reversible piezochromic system comprising an electron donating compound and an electron accepting compound. The electron donating compound is an ionochromic substance which is a pH-sensitive dye, often called a color former. The electron accepting compound acts as a color developer.

The reversible piezochromic system of the present invention is obtained by combining an ionochromic substance(s) with a developer(s) which satisfies the following requirements:
1. The developer function is triggered by the application of a pressure to the system and the effect is reversible.
2. The developer has acidity strong enough to change the color of the ionochromic substance by protonation, yet weak enough to allow the system to remain reversible, that is, to allow it to go back to the initial color of the ionochromic substance. Preferably, the developer has acid value (or acid number) of between about 5 mg and about 10 mg KOH/g of the developer, more preferably between about 7 mg and about 10 mg KOH/g of the developer, and most preferably about 10 mg KOH/g of the developer.
3. The system is flexible enough to allow an electronic exchange to occur between the color former and the developer in both ways, namely, from the initial color to the final color and from the final color to the initial color.

The term “acid value” or “acid number” used herein refers to the amount of free acid present in a material as measured by the milligrams of KOH needed to neutralize 1 g of the material.

The ionochromic compounds suitable for the present invention are electron donating compounds which include, but are not limited to, pH-sensitive dyes, preferably leuco-dyes, or other color formers and the like. Those which are most commonly used often belong to the spirolactone class. The protonation of a colorless or substantially colorless lactone by a weak-acid developer causes the lactone ring to open and results in a formation of a colored compound.

Particularly suitable ionochromic compounds include, but not by way of limitation, phthalide derivatives, such as 3-(2,2-bis(1-ethyl-2-methylindol-3-yl)vinyl)-3-(4-diethylaminophenyl)-phthalide; 3-(4-diethylamino-2-ethoxyphenyl)-3-(1 -ethyl-2-methylindol-3-yl )-4-azaphthalide; 3,3-bis(4-diethylamino-2-ethoxyphenyl)-4-azaphthalide; and 3,3-bis(1-n-octyl-2-methyl-indol-3-yl)phthalide, and fluoran derivatives, such as 3-dibutylamino-6-methyl-7-anilino-fluoran and 3-(N,N-diethylamino)-7-(N,N-dibenzylamino)fluoran.

The developers suitable for the present invention are electron accepting compounds that exhibit acidity high enough to develop the color of the ionochromic compound but low enough to allow the reversibility of the system, i.e., returning to the initial color. Preferably, in one aspect, the developer has acid value (or acid number) of between about 5 mg and about 10 mg KOH/g of the developer, more preferably between about 7 mg and about 10 mg KOH/g of the developer, and most preferably about 10 mg KOH/g of the developer. In another aspect, the developer has a pKa of between about 4.0 and about 5.0, more preferably between about 4.5 and about 5.0, and most preferably between about 4.8 and about 5.0. The ionic exchange between the both components may be triggered by only a weak pressure to the system.

In a preferred embodiment, the developer is a long chained aliphatic acid having at least about 7 carbons, more preferably at least about 9 carbons, and most preferably at least about 11 carbons, in the back bone structure, and preferably having a melting point close to room temperature (i.e., between about 20° C. and 24° C.), or a weakly acidic macromolecule that is isomorphic at room temperature (such as, for example, polysiloxanes having terminal alcohol groups), or mixtures thereof.

In another preferred embodiment, the developer includes a hyper-branched polymer having a plurality of groups of low acidity, preferably about 10 groups or more, more preferably about 14 groups or more, and most preferably about 16 groups or more, and long aliphatic groups, such as ester groups having about 6 to 20 carbons, and preferably about 8 to 18 carbons.

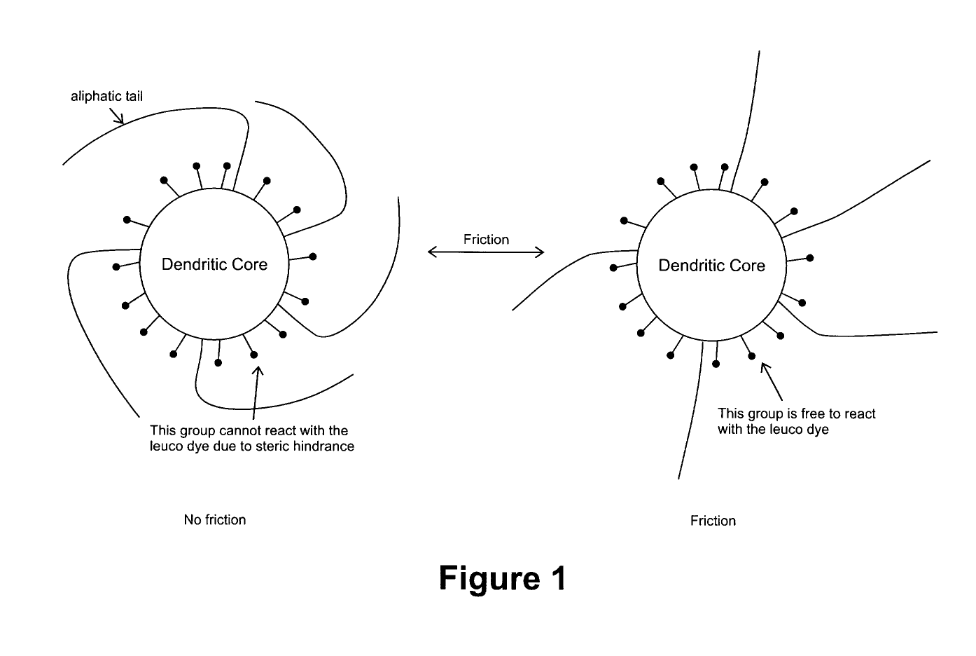

The term “hyper-branched polymer” used herein refers to a dendritic structure otherwise described as a globular size monodisperse macromolecule in which all bonds emerge radially from a central focal point or core with a regular branching pattern and with repeat units that each contributes to a branch point, forming, for example, at least about 10 branches, more preferably at least about 14 branches, and most preferably at least about 16 branches. The low acidic groups, such as hydroxyl groups, form a “functional surface” that participates in the ionic exchange with the ionochromic dye, and the long aliphatic ester groups form long flexible tails around the acidic core (or dendritic core). Thus, the developer forms a giant spherical micelle-like structure. When a pressure is applied to the developer, the aliphatic chains are displaced and allows the ionic exchange to occur between the ionochromic compound and the low acidic groups that have been protected by the aliphatic chain, as depicted in FIG. 1. This phenomenon creates a temporary state of an induced lyotropic mesomorphism.

One skilled In the art will know which developer to use, considering that the acidity of the developer is such that it is high enough to develop the color or the ionochromic compound but low enough to allow the reversibility of the system. Preferably, in one aspect, the developer has acid value (or acid number) of between about 5 mg and about 10 mg KOH/g of the developer, more preferably between about 7 mg and about 10 mg KOH/g of the developer, and most preferably about 10 mg KOH/g of the developer. In another aspect, the developer has pKa of between about 4.0 and about 5.0, more preferably between 4.5 and about 5.0, and most preferably between about 4.8 and about 5.0.

The ratio of the ionochromic compound to the developer may vary according to a desired contrast, color change and relaxation time. It is preferred that the ratio be at least 1 to 1, more preferably 1 to 2, or greater.

In a specific embodiment, a preferred ionochromic compound is 3-(2,2-bis( -ethyl-2-methylindol-3-yl)vinyl)-3-(4-diethylaminophenyl)-phthalide (GN-169 from Yamamoto chemical) and a developer is undecanoic acid. The preferred ratio of these two (2) components is 1 to 2. The components may be mixed together at room temperature or at lower temperatures.

The coloration which can be obtained by pressure depends on the ionochromic dyes used and their intrinsic coloration. All the range of colors can be achieved. Some examples are as follows:
a pink color may be obtained by using 3-diethylamino-7,8-benzofluoran (Red 3 from Yamamoto Chemical), or a color former (Pergascript 1-6B from Ciba Specialty Chemical), or a color former (Red 520 from Yamada Chemical), or 6′-diethylamino-2′chlorofluoran, or the like.
a black color may be achieved by using 3-dibutylamino-6-methyl-7-anilino-fluoran (ODB2 from Yamamoto Chemical), or the like.
a green color may be obtained by using 3-(N,N-diethylamino)-7-(N,N-dibenzylamino)fluoran (Green DCF from Hodogaya Chemical), or 3,3-bis(4-diethylamino2-ethoxyphenyl)-4-azaphthalide (GN-2 from Yamamoto Chemical), or the like.
a blue color may be achieved using 3-(4-diethylamino-2-ethoxyphenyl)-3-(1-ethyl-2-methylindol-3-yl)-4-azaphthalide (Blue 63 from Yamamoto Chemical), or 3-(2,2-bis(1 -ethyl-2-methylindol-3-yl)vinyl)-3-(4-diethylaminophenyl)-phthalide (GN-169 from Yamamoto Chemical), or the like.

The color change can be from a colorless or substantially colorless state to a colored state or vice versa, or from a first color to a second color or vice versa, using a pigment in the mixture. For example, by adding a blue color former to a yellow pigment in the system, a yellow to green system can be achieved. In a specific embodiment, the color change is detectable both by human eyes and by colorimetric measurement. In another specific embodiment, the color change is detected either by human eyes or by calorimetric measurement. For example, if the color change is only detectable by colorimetric measurement, the piezochromic reaction is not easily detectable by a forger.

The reversible piezochromic system of the invention may be used in printing inks, for example, to protect banknotes against forgeries. The reversible piezochromic system of the invention may be mixed with a suitable ink vehicle which will not react with either the ionochromic compound or the developer of the system. One with ordinary skill in the art can easily select which ink vehicle is suitable for a given application. The printing inks of the present invention can be air dried or UV cured. For a banknote application, an intaglio ink is preferable.

The resin systems which can be used as an ink vehicle to carry the piezochromic systems include, but are not limited to, an oleoresinous intaglio vehicle and a UV screen vehicle. Some problems in stability may be observed with intaglio vehicle systems, for example, one comprising a polyester extender base of about 50-70%, vegetable oil of about 100-30%, a drier (for example, cobalt drier) of about 1-10%, alkyd acid of about 1-10% and white spirit of about 1-10%. While not being bound by a theory, it is believed that, in one aspect, the instability is caused by an acidic reaction between the cobalt drier or the alkyd acid and the ionochromic dye. Replacing the cobalt drier with calcium driers and removing the alkyd acid improves the stability of the system. However, although Ca may improve the stability of the ink film, it may prolong a drying time, thereby causing a long turn around time, and deteriorate the mechanical resistance of the printed ink. In another aspect, entanglement of polymer chains, after the system has been fully oxidized, may restrict the mobility of aliphatic acid and affect the stability of the system. One skilled in the art will be aware of the adjustment which can be adapted to address these problems when they are encountered.

Some dyes have been found to be more suitable than others for the piezochromic systems of the present invention. The choice of dye depends on a tinctorial strength of the dye and the time required for the color reversal, which, in turn, depends on the stability of the colored ionochromic dye after the pressure has been removed. For example, the greater the pressure required to produce the change in color, the faster the color reversal. This phenomenon follows the thermodynamic principles.

The reversible piezochromic system of the present invention is further illustrated by the following non-limiting examples, in which all parts and percentages are by weight and all temperatures are in centigrade, unless otherwise indicated.

### EXAMPLE 1

The reversible piezochromic system of the present invention was formulated by adding 3-(2,2-bis(l-ethyl-2-methylindol-3-yl)vinyl)-3-(4-diethylaminophenyl)-phthalide (GN-169 from Yamamoto chemical) (20 parts) to undecanoic acid (80 parts) at around 18° C. so that both components were in a powder state.

The mixture was spread between two glass plates and exhibited a white color. When a little shear force was applied between the both plates, a blue color appeared and, once the shear force was removed, the blue color disappeared and the mixture was colorless again. Thus the effect was reversible.

### EXAMPLE 2

The reversible piezochromic system of the present invention was formulated directly in an ink system by adding 3-(2,2-bis(1-ethyl-2-methylindol-3-yl)vinyl)-3-(4-diethylaminophenyl)-phthalide (GN-169 from Yamamoto chemical; 43 parts) to undecanoic acid (101 parts), a urethane alkyd resin from Cray Valley LTD (E20175: 144 parts), and a drier Ca 41 DBP from Borchers (8.7 parts) at room temperature. The resulting ink was printed with a silk screen of 90 meshes on a sheet of paper. The color of the dried print was a light blue. Once a frictional force was applied to the printed sample, a dark blue color emerged and then disappeared after the friction was removed. The effect was reversible.

### EXAMPLE 3

The reversible piezochromic system of the present invention was also formulated directly in an ink system by adding 3-(2,2-bis(1-ethyl-2-methylindol-3-yl)vinyl)-3-(4-diethylaminophenyl)-phthalide (GN-169 from Yamamoto Chemical; 60.6 parts) to undecanoic acid (51.2 parts), an urethane alkyd resin from Cray Valley LTD (E20175; 115 parts), natural calcium carbonate (Britomya M from Omya UK Ltd; 16.6 parts), a cobalt driers mixture (Sun Chemical Gibbon; 2 parts), Durham manganese 10 (Elementis Pigments; 2 parts), and Zirconium HF grades (Ellis & Everard; 2 parts) at room temperature.

The resulting ink was printed with a silk screen of 90 meshes on a sheet of paper. The color of the dried print is a cream color or a very light brown. Once a frictional force was applied to the printed sample, a blue color appeared and subsequently disappeared after the friction was removed. The effect was reversible.

### EXAMPLE 4

The reversible piezochromic system of the present invention was formulated directly in an ink system by adding 3-dibutylamino-6-methyl-7-anilino-fluoran (Pergascript 1-2R from Ciba SC; 40 parts) to undecanoic acid (100 parts), an ultra-violet curable ink vehicle (Viascreen 500 from UCB; 150 parts), a photoinitiator (Irgacure 754 from Ciba; 27 parts), an hexamethylene diacrylate (HDDA from UCB; 40 parts) and an acrylated amine oligomer hexamethylene diacrylate (Ebecryl 7100 from UCB; 30 parts) at room temperature.

The resulting ink was printed with a silk screen of 90 meshes on a sheet of paper. The print was irradiated under a UV lamp at 1200 watts for curing and the color of the cured print was white. Once a frictional force was applied to the printed sample, a dark gray color appeared and then disappeared after the friction was removed. The effect was reversible.

### EXAMPLE 5

Hyper-branched alcohols were tested as developers in the reversible piezochromic system of the present invention. Hydroxyl-functional dendritic polyesters which are fully aliphatic and consisting only of tertiary ester bonds, were tested and shown to have excellent thermal and chemical resistance in the printed ink. The extensive branching also contributed to their better reactivity as well as lower viscosity than straight-chain counterparts. The tested hyper branched alcohols were a variety of dendritic polyesters of the Boltorn type (from Perstorp Specialty Chemical) as shown in Table 1 below.

TABLE 1

| | Tg (DMA) | Viscosity | | OH Value | Acid Value |
|---|---|---|---|---|---|
| Boltorn Name | ° C. | Pas (° C.) | | mg KOH/g* | mg KOH/g |
| U3000 | No data | 1 | (23) | 15 | 10 |
| (average of 14 unsaturated | available | | | | |
| fatty ester, virtually | | | | | |
| fully capped with drying | | | | | |
| C18 acid) | | | | | |
| H2003 | −5 | 1 | (110) | 298 | 5.2 |
| (12 primary OH groups: | | | | | |
| functionality 12 and chain | | | | | |
| stopped by a C8-C10 | | | | | |
| saturated fatty acid on 4 | | | | | |
| of the 16 original OH groups) | | | | | |
| H2004 | −35 | 15 | (23) | 119 | 5.1 |
| (6 primary OH groups: | | | | | |
| functionality 6 and chain | | | | | |
| stopped by a C8-C10 | | | | | |
| saturated fatty acid on | | | | | |
| 10 of the 16 original OH | | | | | |
| groups) | | | | | |
| H30 | 35 | 40 | (110) | 500 | 7.2 |
| (32 primary OH groups: | | | | | |
| functionality 32) | | | | | |

*The term “OH value” used herein refers to the milligrams of KOH equivalent to the OH in 1 g of material.

The developers were formulated directly in an oleoresinous printing ink system by mixing together with color formers at different ratios as described in Table 3 below. A mixture of a developer and a color former, often called “an active principle,” and was added to an urethane alkyd resin (E20175 from Cray Valley LTD) at different ratios (i.e., active principle/resin ratio in the table below) with a drier Ca 41 DBP from Borchers at about 10% to about 30%, preferably about 16% of the amount of resin+active principle.

The properties of the color formers used in this example are set forth in Table 2 below.

TABLE 2

| Color former | | | |
|---|---|---|---|
| name | Chemical name | Developed color | Producer |
| Blue 63 | 3-(4-diethylamino-2- | Blue | Yamamoto |
| | ethoxyphenyl)-3-(1- | | Chemical |
| | ethyl-2-methylindol-3- | | |
| | yl)-4-azaphthalide | | |
| GN-169 | 3-(2,2-bis(1-ethyl-2- | Blue | Yamamoto |
| | methylindol-3- | | Chemical |
| | yl)vinyl)-3-(4- | | |
| | diethylaminophenyl)- | | |
| | phthalide | | |
| GN-2 | 3,3-bis(4- | Green | Yamamoto |
| | diethylamino2- | | Chemical |
| | ethoxyphenyl)-4- | | |
| | azaphthalide | | |
| I-2GN | 3-(N,N-diethylamino)- | Green | Ciba Specialty |
| | 7-(N,N- | | Chemical |
| | dibenzylamino)fluoran | | |
| I-6B | 3,3-bis(1-n-octyl-2- | Red | Ciba Specialty |
| | methyl-indol-3- | | Chemical |
| | yl)phthalide | | |

The printing inks were silk-screen printed on a mesh of 120 on paper by hand. The inks were tested for piezochromic reversibility by applying a friction with the round extremity of a spatula to the printed inks on the paper substrate and measuring the color change time in seconds. If the relaxation time (time to return to the original color) was over 1,000 seconds, the ink was deemed “too slow”. The results are set forth in Table 3 below.

TABLE 3

| | Developper | | | | | | | | |
|---|---|---|---|---|---|---|---|---|---|
| | Boltorn | Leuco | Dendrimer | | | | | | |
| Leuco dye | Dendrimer | weight | weight | Alkyd resin | Ratio leuco/ | ratio leuco/ | Color under | Reversibility | |
| (Color former) | Name | g | g | weight | hydroxyl number | acid no. | pressure | (second) | Comment |
| Blue 63 | U3000 | 0.2 | 0.57 | 0.8 | 0.31 | 0.47 | blue | Too slow | |
| Blue 63 | U3000 | 0.1 | 0.5 | 0.8 | 0.18 | 0.27 | blue | 40 | quick |
| Blue 63 | U3000 | 0.05 | 0.54 | 0.5 | 0.08 | 0.12 | light bluish | 40 | quick |
| Blue 63 | U3000 | 0.5 | 0.5 | 1.1 | 0.90 | 1.35 | blue | 600 | very slow |
| Blue 63 | U3000 | 0.4 | 1.4 | 0 | 0.26 | 0.38 | blue | 90 | |
| Blue 63 | U3000 | 0.5 | 1 | 1 | 0.45 | 0.67 | blue | 60 | |
| Blue 63 | H2004 | 0.2 | 0.51 | 0.8 | 0.02 | 0.51 | none | Too slow | |
| Blue 63 | H2004 | 0.1 | 0.69 | 0.8 | 0.01 | 0.19 | none | Too slow | |
| Blue 63 | H2003 | 0.22 | 0.57 | 1 | 0.01 | 0.38 | none | Too slow | |
| GN-169 | U3000 | 0.5 | 0.5 | 1 | 0.71 | 1.07 | blue | 600 | very slow |
| GN-169 | U3000 | 0.29 | 0.59 | 1 | 0.35 | 0.52 | blue | 90 | |
| GN-169 | U3000 | 0.5 | 3 | 0 | 0.12 | 0.18 | blue | 120 | |
| GN-169 | U3000 | 0.1 | 0.5 | 0.6 | 0.14 | 0.21 | blue | 30 | very quick |
| GN-169 | U3000 | 0.22 | 0.54 | 0.7 | 0.29 | 0.43 | blue | 60 | quick |
| GN-169 | U3000 | 0.13 | 0.67 | 1 | 0.14 | 0.21 | blue | 20 | very quick |
| GN-169 | H2003 | 0.5 | 0.5 | 1.5 | 0.01 | 0.79 | blue | 300 | slow |
| GN-169 | H2003 | 0.5 | 0.5 | 1.5 | 0.01 | 0.79 | | 300 | slow |
| GN-169 | H2004 | 0.5 | 0.5 | 1.5 | 0.04 | 1.03 | blue | 90 | |
| GN-169 | H2004 | 0.25 | 0.3 | 1.5 | 0.04 | 0.86 | blue | 60 | |
| GN-169 | H2004 | 0.5 | 0.5 | 1 | 0.04 | 1.03 | blue | 60 | |
| GN-2 | H2003 | 0.5 | 0.5 | 1.5 | 0.02 | 0.93 | nothing | Too slow | |
| GN-2 | U3000 | 0.2 | 0.54 | 0.7 | 0.31 | 0.47 | nothing | Too slow | |
| I-2GN | H2003 | 0.5 | 0.5 | 1 | 0.01 | 0.85 | | Too slow | |
| I-2GN | U3000 | 0.52 | 0.5 | 1.5 | 0.80 | 1.19 | green | 120 | |
| I-2GN | U3000 | 0.25 | 0.5 | 1 | 0.38 | 0.57 | green | 180 | |
| I-2GN | U3000 | 0.5 | 1 | 0 | 0.38 | 0.57 | Green | 120 | |
| I-2GN | U3000 | 0.2 | 0.52 | 0.8 | 0.29 | 0.44 | green | 180 | |
| I-2GN | U3000 | 0.5 | 0.8 | 1.2 | 0.48 | 0.72 | green | 40 | quick |
| I-2GN | U3000 + | 0.5 | 0.25 | 1 | | | none | Too slow | |
| | H2003 | | 0.25 | | | | | | |
| I-2GN | U3000 + | | | 1 | | | light greenish | 50 | |
| | H2004 | | | | | | | | |
| I-2GN | H2003 | 0.5 | 0.5 | 1.5 | 0.01 | 0.85 | green | 300 | slow |
| I-2GN | H2003 | 0.5 | 0.5 | 1.5 | 0.01 | 0.85 | green | 300 | slow |
| I-2GN | H2003 | 0.5 | 0.5 | 1 | 0.01 | 0.85 | light green | 120 | flaky |
| I-2GN | H2004 | 0.5 | 0.5 | 1.5 | 0.05 | 1.11 | green | 150 | slow |
| I-2GN | H2004 | 0.1 | 0.5 | 1.3 | 0.01 | 0.22 | nothing | 150 | slow |
| I-2GN | H2004 | 0.5 | 0.5 | 1 | 0.05 | 1.11 | green | 40 | flaky |
| I-6B | H2004 | 0.5 | 0.5 | 1.5 | 0.04 | 1.02 | light light red | 15 | very quick |

Those skilled in the art will recognize, or be able to ascertain many equivalents to the specific embodiments of the invention described herein using no more than routine experimentation. Such equivalents are intended to be encompassed by the following claims.

All publications, patents and patent applications mentioned in this specification are herein incorporated by reference in their entireties. Citation or discussion of a reference herein shall not be construed as an admission that such is prior art to the present invention.

What is claimed is:

1. A reversible piezochromic system comprising an electron donating compound and an electron accepting compound, wherein the combination of the electron donating compound and the electron accepting compound is reversibly piezochromic and a color change is detectable by the human eye, calorimetric measurement, or both.

2. The system of claim 1, wherein the electron donating compound comprises a a pH-sensitive dye.

3. The system of claim 2, wherein the pH-sensitive dye is a leuco-dye.

4. The system of claim 2, wherein the electron donating compound is a spirolactone.

5. The system of claim 4, wherein the electron donating compound is a fluoran derivative.

6. The system of claim 5, wherein the electron donating compound is selected form the group consisting of 3-dibutylamino-6-methyl-7-anilino-fluoran and 3-(N,N-diethylamino)-7-(N,N-dibenzylamino)fluoran.

7. The system of claim 4 wherein the electron donating compound is a phthalide derivative.

8. The system of claim 7 wherein the electron donating compound is selected from the group consisting of 3-(2,2-bis(1-ethyl-2-methylindol-3-yl)vinyl)-3-(4-diethylaminophenyl)-phthalide; 3-(4-diethylamino-2-ethoxyphenyl)-3-(1-ethyl-2-methylindol-3-yl )-4-azaphthalide; 3 ,3-bis(4-d iethylamino-2-ethoxyphenyl)-4-azaphthalide; and 3,3-bis(1-n-octyl-2-methyl-indol-3-yl)phthalide.

9. The system of claim 1, wherein the electron accepting compound has an acid value between about 5 mg and about 10 mg KOH per 1 gram of the electron accepting compound.

10. The system of claim 1, wherein the electron accepting compound has a pKa of between about 4.0 and about 5.0.

11. The system of claim 1 wherein the electron accepting compound comprises a long chained aliphatic acid having at least about 11 carbons in a backbone structure and a melting point in a temperature range of about 20° C. and about 24° C., or a weakly acidic macromolecule which is isomorphic in said temperature range, or a mixture thereof.

12. The system of claim 11, wherein the electron accepting compound is a hyper-branched polymer having at least about 10 branches.

13. The system of claim 11, wherein the electron accepting compound is a polysiloxane having terminal alcohol groups.

14. The system of claim 11, wherein the electron accepting compound is undecanoic acid.

15. The system of claim 1, wherein the weight ratio of the electron donating compound to the electron accepting compound is at least 1:1.

16. The system of claim 1, wherein a color of the system changes from a first color to a second color and vice versa.

17. The system of claim 1, wherein a color of the system changes from a substantially colorless to a colored state and vice versa.

18. A printing ink comprising the reversible piezochromic system of claim 1.

19. The printing ink of claim 18, wherein the ink is energy curable.

20. The printing ink of claim 18, wherein the ink is an intaglio printing ink, or a screen printing ink.

21. A method for producing a reversible piezochromic systems comprising combining an electron donating compound and an electron accepting compound, wherein the combination of the electron donating compound and the electron accepting compound is reversibly piezochromic.
